(19) United States
(12) Patent Application Publication
(10) Pub. No.: US 2017/0268745 A1
(43) Pub. Date: Sep. 21, 2017

(54) Reflector Inserts for Emergency Egress Light Fixtures

(71) Applicant: Anthony Ryan Gibbs, Atlanta, GA (US)

(72) Inventor: Anthony Ryan Gibbs, Atlanta, GA (US)

(21) Appl. No.: 14/614,988

(22) Filed: Feb. 5, 2015

(51) Int. Cl. F21V 7/00; F21S 8/00; F21V 17/00

(52) U.S. Cl. CPC F21V 7/0083; F21V 17/002; F21S 8/036; F21Y 2101/02

(57) ABSTRACT

An emergency egress light fixture is disclosed herein. The emergency egress light fixture can include a first light chamber base forming a first light chamber, where the first light chamber base includes at least one first reflector insert coupling feature. The emergency egress light fixture can also include at least one first light source disposed in the first light chamber. The emergency egress light fixture can further include a first reflector insert disposed within the at least one first reflector insert coupling feature, where the first reflector insert divides the first light chamber into a first portion and a second portion, where the at least one first light source is disposed in the first portion, and where the second portion is substantially dark when the at least one first light source is illuminated.

### TECHNICAL FIELD

Embodiments described herein relate generally to emergency egress lighting, and more particularly to reflectors for emergency egress light fixtures.

### BACKGROUND

Emergency lighting is a requirement in many buildings and enclosed spaces. Emergency lighting is designed to activate in an emergency situation (e.g., power failure, fire) to provide egress lighting for people inside the building or enclosed space during the emergency situation. The emergency lighting must not only be installed according to certain codes and regulations, but the emergency lighting must also function properly when called upon. Often, activating the emergency is an automatic process that occurs when the emergency situation arises.

### SUMMARY

In general, in one aspect, the disclosure relates to an emergency egress light fixture. The emergency egress light fixture can include a first light chamber base forming a first light chamber, where the first light chamber base includes at least one first reflector insert coupling feature. The emergency egress light fixture can also include at least one first light source disposed in the first light chamber. The emergency egress light fixture can further include a first reflector insert disposed within the at least one first reflector insert coupling feature, where the first reflector insert divides the first light chamber into a first portion and a second portion, where the at least one first light source is disposed in the first portion, and where the second portion is substantially dark when the at least one first light source is illuminated.

In another aspect, the disclosure can generally relate to a reflector insert for an emergency egress light fixture. The reflector insert can include a body having a first side and a second side, where the first side is reflective. The reflector insert can also include a bottom edge positioned adjacent to the first side and the second side, where the bottom edge has a light chamber base contour that substantially complements the light chamber base contour of a light chamber base of the emergency egress light fixture. The bottom edge can be configured to be disposed within at least one reflector insert coupling feature of the light chamber base. The body divides a light chamber formed by the light chamber base into a first portion and a second portion, where at least one first light source is disposed in the first portion, where the first side of the body faces the first portion, and where the second portion is substantially dark when the at least one first light source is illuminated.

In yet another aspect, the disclosure can generally relate to an emergency egress light fixture. The emergency egress light fixture can include a light chamber base forming a light chamber, and at least one light source disposed in the first light chamber. The emergency egress light fixture can also include an optical device coupled to the light chamber base, where the light chamber base includes at least one reflector insert coupling feature. The emergency egress light fixture can further include a reflector insert disposed within the at least one reflector insert coupling feature, where the reflector insert divides the light chamber into a first portion and a second portion, where the at least one light source is disposed in the first portion, and where the second portion is substantially dark when the at least one light source is illuminated.

These and other aspects, objects, features, and embodiments will be apparent from the following description and the appended claims.

### BRIEF DESCRIPTION OF THE DRAWINGS

The drawings illustrate only example embodiments of reflector inserts for emergency egress light fixtures and are therefore not to be considered limiting of its scope, as reflector inserts for emergency egress light fixtures may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIGS. 1A and 1B show an emergency egress light fixture in accordance with embodiments known in the art.

FIGS. 2A and 2B show light distribution of an emergency egress light fixture in accordance with embodiments known in the art.

FIGS. 3A and 3B show an emergency egress light fixture in accordance with certain example embodiments.

FIG. 4 shows a reflector insert in accordance with certain example embodiments.

FIGS. 5A and 5B show light distribution of an emergency egress light fixture in accordance with certain example embodiments.

### DETAILED DESCRIPTION OF EXAMPLE EMBODIMENTS

The example embodiments discussed herein are directed to systems, methods, and devices for reflector inserts for emergency egress light fixtures. Certain example embodiments provide a number of benefits. Examples of such benefits include, but are not limited to, ease of installation and removal, field installation capability, low cost, and more efficient and effective light distribution.

While the example embodiments described herein are directed to reflector inserts for emergency egress light fixtures that are assembled in the field, example embodiments can be assembled as part of the manufacturing process or in some other setting rather than in the field. Therefore, example embodiments described herein should not be considered limited to assembly at any particular location and/or by any particular person. Further, while example embodiments described herein are directed to emergency egress light fixtures, example embodiments can also be used with other types of light fixtures. Therefore, example embodiments described herein should not be considered limited to use with emergency egress light fixtures.

The light fixtures (or components thereof, such as the reflector inserts) described herein can be made of one or more of a number of suitable materials and/or configured in certain ways to allow the light fixtures to meet certain standards and/or regulations while also maintaining reliability in light of the one or more conditions under which the example light fixtures can be exposed. Examples of such materials can include, but are not limited to, aluminum, stainless steel, fiberglass, glass, plastic, and rubber.

As discussed above, example light fixtures can be subject to meeting one or more of a number of standards, codes, regulations, and/or other requirements established and maintained by one or more entities. Examples of such entities can include, but are not limited to, Underwriters' Laboratories, the Institute of Electrical and Electronics Engineers, and the National Fire Protection Association. For example, wiring (the wire itself and/or the installation of such wire) that electrically couples a base unit with a remote emergency light fixture may fall within one or more standards set forth in the National Electric Code (NEC).

Any components (e.g., housing, reflector inserts) of example light fixtures, or portions thereof, described herein can be made from a single piece (as from a mold, injection mold, die cast, or extrusion process). In addition, or in the alternative, a component (or portions thereof) can be made from multiple pieces that are mechanically coupled to each other. In such a case, the multiple pieces can be mechanically coupled to each other using one or more of a number of coupling methods, including but not limited to epoxy, welding, fastening devices, compression fittings, mating threads, and slotted fittings. One or more pieces that are mechanically coupled to each other can be coupled to each other in one or more of a number of ways, including but not limited to fixedly, hingedly, removeably, slidably, and threadably.

As described herein, a user can be any person that interacts with a light fixture. Examples of a user may include, but are not limited to, an engineer, an electrician, a maintenance technician, a mechanic, an employee, a visitor, an operator, a consultant, a contractor, and a manufacturer's representative.

Example embodiments of reflector inserts for emergency egress light fixtures will be described more fully hereinafter with reference to the accompanying drawings, in which example embodiments of reflector inserts for emergency egress light fixtures are shown. Reflector inserts for emergency egress light fixtures may, however, be embodied in many different forms and should not be construed as limited to the example embodiments set forth herein. Rather, these example embodiments are provided so that this disclosure will be thorough and complete, and will fully convey the scope of reflector inserts for emergency egress light fixtures to those of ordinary skill in the art. Like, but not necessarily the same, elements (also sometimes called components) in the various figures are denoted by like reference numerals for consistency.

Terms such as “first,” “second,” “top,” “bottom,” “left,” “right,” “end,” “back,” “front,” “length,” “width,” “inner,” “outer,” “lower”, and “upper” are used merely to distinguish one component (or part of a component or state of a component) from another. Such terms are not meant to denote a preference or a particular orientation, and are not meant to limit embodiments of reflector inserts for emergency egress light fixtures. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

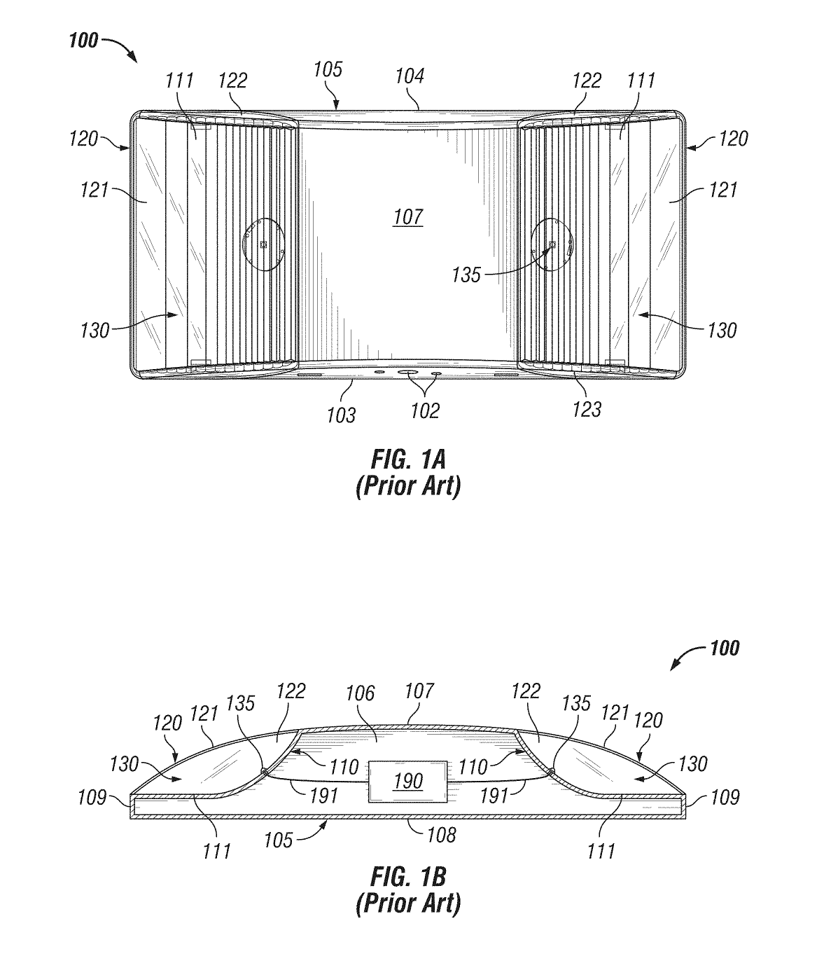

FIGS. 1A and 1B show a front and a cross-sectional top side view, respectively, of an emergency egress light fixture 100 in accordance with embodiments currently used in the art. The light fixture 100 includes a housing 105, electrical components 190, two light chamber bases 110, two light sources 135, and two optical devices 120. The light chamber bases 110, the light sources 135, and optical devices 120 in this case are disposed symmetrically with respect to each other on the housing. In other words, when viewed from the front (as in FIG. 1A) or the top side (as in FIG. 1B), the left side of the light fixture 100 is symmetrical with the right side of the light fixture 100.

The housing 105 has a top end 104, a bottom end 103, a back end 108, a front end 107, and two sides 109. These portions of the housing 105 can form a cavity 106 inside of which can be disposed the electrical components 190. The electrical components 190 provide, directly or indirectly, power and/or control signals to the light fixture 100 and control the illumination of the light sources 135. Examples of the electrical components 190 can include, but are not limited to, one or more electrical cables, electrical wires 191, integrated circuits, discrete electrical components (e.g., resistors, capacitors, diodes), transformers, inverters, converters, terminal blocks, circuit boards, controllers, drivers, ballasts, batteries, and electrical connectors.

The bottom end 103 of the housing 105 can have one or more apertures 102 to which one or more conduits (not shown) can be coupled. In such a case, one or more electrical components 190 (e.g., electrical cables) can be disposed inside the conduit, where a portion of the electrical components 190 are also disposed inside the cavity 106 of the housing 105 to provide power and/or control signals to the light sources 135.

Each light chamber base 110 can be coupled to the housing or can be considered part of the housing 105. In this case, each light chamber base 110 is disposed between the top end 104, the bottom end 103, the front end 107, and a side 109. A light chamber base 110 can have a contour 111 (e.g., a curvature) along its length (in this case, the portion of the light chamber base 110 disposed between the front end 107 and the side 109). The contour 111 of the light chamber base 110 can be substantially uniform or varied along its length. The contour 111 can have one or more of a number of features along its length. For example, the contour 111 can be smooth, curved, sawtooth-shaped, concave, convex, and/or textured.

Similarly, the contour 111 along the width (in this case, the portion of the light chamber base 110 disposed between the top end 104 and the bottom end 103) of a light chamber base 110 can be substantially uniform or varied. The features of the contour 111 of a light chamber base 110 can be selected based on a desired optical effect of the light emitted by the light sources 135. The characteristics (e.g., size, contour 111) of a light chamber base 110 of a light fixture 100 can be the same as, or different than, the corresponding characteristics of the other light chamber bases 110 of the light fixture 100.

A light chamber base 110 can form, at least in part, a light chamber 130. A light chamber 130 is a volume of space in which light emitted from a light source 135 is manipulated before being transmitted beyond the light fixture 100. In addition to a light chamber base 110, a light chamber 130 can be bounded by an optical device 120, described below. A light source 135 can be disposed on a light chamber base 110 and directed toward the light chamber 130. Alternatively, a light source 135 can be positioned within the light chamber 130. As yet another alternative, a light source 135 can be disposed beneath a light chamber base 110, where light emitted by the light source 135 is directed through one or more apertures in the light chamber base 110 into the light chamber 130.

Each light source 135 emits light when the light source 135 receives a power signal. Each light source 135 can be any of a number of different types of light source. Examples of light source types of a light source 135 can include, but are not limited to, incandescent lamps, light-emitting diodes (LEDs), halogen lamps, G10/GU10, G9/GU9, AR111/PAR36, T3, MR-11, and MR-16. If the light source 135 is a LED, the LED can be of one or more of a number of types of LED technology, including but not limited to discrete LEDs, LED arrays, chip-on-board LEDs, edge lit LED panels, and surface mounted LEDs. A light source 135 can be a single source of light or multiple sources (e.g., an array) of light.

Each optical device 120 is configured to protect the light source 135 in the light chamber 135 from external elements (e.g., debris, dirt) and/or to manipulate light emitted by the light sources 135 in one or more of a number of ways, including but not limited to filtering, diffusion, reflection, and refraction. An optical device 120 (also called, for example, a lens or a diffuser) can be of any suitable size, color, thickness, texture, opacity, and shape. An optical device 120 can also be made of one or more of a number of suitable materials, including but not limited to plastic, such as acrylic, and glass.

As discussed above, an optical device 120 can be coupled to a light chamber base 110, thereby forming the light chamber 130. The optical device 120 can have a top surface 121 and two side surfaces (side surface 122, side surface 123). In such a case, the top surface 121 couples (e.g., hingedly, using snap fittings) to or abuts against the front end 107 and a side 109 of the housing 105, the side surface 122 couples to or abuts against the top end 104, and the side surface 123 couples to or abuts against the bottom end 103.

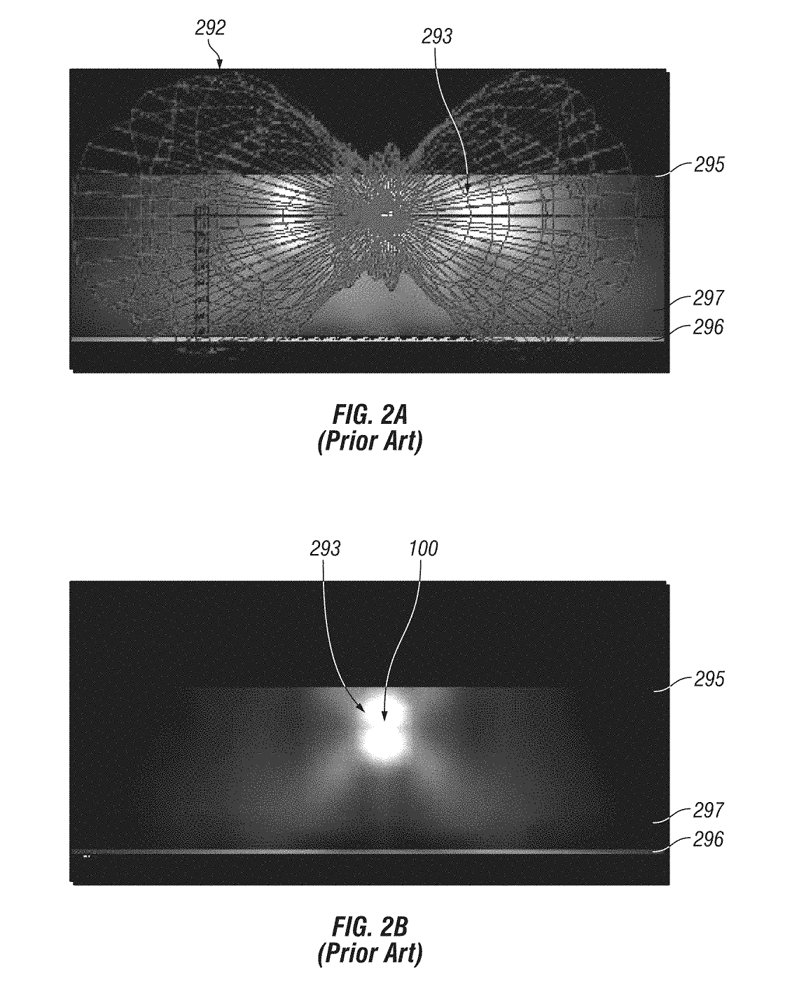

FIGS. 2A and 2B show light distribution of the emergency egress light fixture 100 of FIGS. 1A and 1B in accordance with embodiments known in the art. Specifically, FIG. 2A shows a graphical representation 292 (overlayed on a visual representation 293) of the light dispersion pattern, and FIG. 2B shows the visual representation 293 of the light dispersion pattern by itself. The light fixture 100 is hidden from view in FIG. 2A by the graphical representation 292.

When the light fixture 100 is mounted on a wall 297, as shown in FIGS. 2A and 2B, the light dispersion pattern, represented both by the graphical representation 292 and the visual representation 293, is directed upward and downward (relative to the light fixture 100) substantially equally. In other words, the light emitted by the light fixture 100 in currently used embodiments is directed toward the ceiling 295 as much as it is directed toward the floor 296. Since this light is designed to provide illumination for people, both during normal conditions and during emergencies, in what are often otherwise darkly lit spaces, the light that is directed toward the ceiling 295 is wasted and of no use to a user. This results in a significant waste of energy resources.

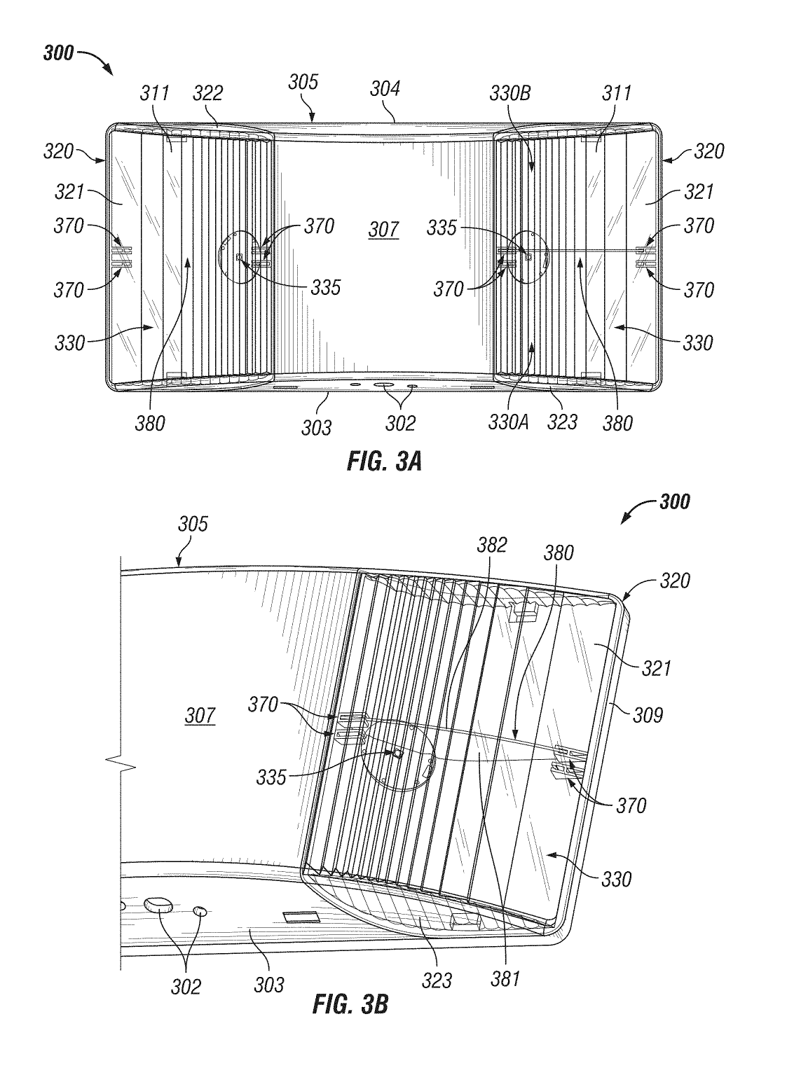

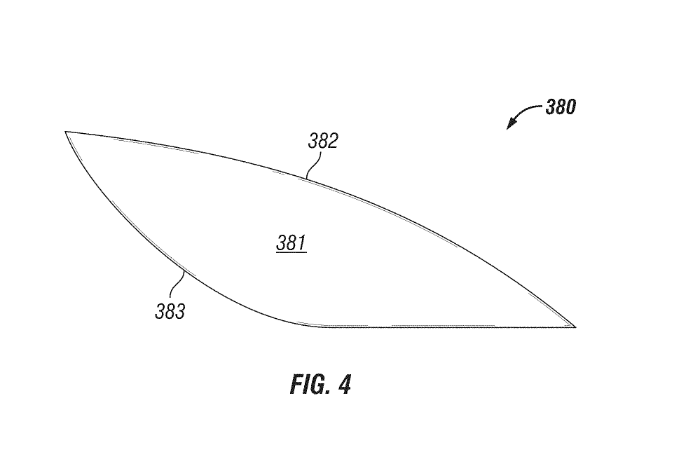

To minimize the waste of energy and make significantly more use of the light emitted by the light sources 135 of the light fixture 100, example embodiments have been developed. FIGS. 3A and 3B show an emergency egress light fixture 300 in accordance with certain example embodiments. FIG. 4 shows a reflector insert in accordance with certain example embodiments. In one or more embodiments, one or more of the components shown in FIGS. 3A-4 may be omitted, repeated, and/or substituted. Accordingly, embodiments of a reflector insert and/or an emergency egress light fixture should not be considered limited to the specific arrangements of components shown in FIGS. 3A-4.

Referring to FIGS. 1A-4, the emergency egress light fixture 300 of FIGS. 3A and 3B is substantially the same as the emergency egress light fixture 100 of FIGS. 1A and 1B, except as described below. Further, if a component (e.g., housing 305, optical device 320) of FIGS. 3A and 3B is described but not expressly shown or labeled in FIGS. 3A and 3B, the label used for a corresponding component (e.g., housing 105, optical device 120) in FIGS. 1A and 1B can be inferred from that corresponding component. Conversely, if a component in FIGS. 3A and 3B is labeled but not described, the description for such component can be substantially the same as the description for the corresponding component in FIGS. 1A and 1B. The numbering scheme for the various components in FIGS. 3A and 3B herein is such that each component is a three digit number and corresponding components in FIGS. 1A and 1B have the identical last two digits.

In certain example embodiments, one or more of a number of reflector insert coupling features 370 are disposed on the light chamber base 310. For example, as shown in FIGS. 3A and 3B, each light chamber base 310 includes four reflector insert coupling features 370. Specifically, two reflector insert coupling features 370 are disposed on the light chamber base 310 adjacent to the side 309 of the housing 305, and two other reflector insert coupling features 370 are disposed on the light chamber base 310 adjacent to the front end 307 of the housing 305.

In this case, the reflector insert coupling features 370 are disposed on each side of the light chamber base 310 symmetrically about a midpoint between the top end (adjacent to the top end 304 of the housing 305) and the bottom end (adjacent to the bottom end 303 of the housing 305) of the light chamber base 310. In this way, the orientation (e.g., right-side-up, upside down) of the light fixture 300 can be irrelevant when the light fixture 300 is attached to a wall (e.g., wall 297). In addition, or in the alternative, the reflector insert coupling features 370 can be disposed at one or more other locations along the light chamber base 310.

The reflector insert coupling features 370 can be laid out symmetrically and/or randomly on the light chamber base 310 from any perspective (e.g., vertically, horizontally). In certain example embodiments, as in this example, one or more of the light sources 335 is located approximately at the midpoint between the top end and the bottom end of the light chamber base 310. Alternatively, a light source 335 can be located at any other point on the light chamber base 310. The light chamber base 110 can be made of and/or coated with one or more of a number of reflective materials.

In certain example embodiments, a reflector insert coupling feature 370 can be any type of coupling device that receives and retains, directly or indirectly, a portion of a reflector insert 380. A reflector insert coupling feature 370 can have one or more of a number of configurations. For example, as shown in FIGS. 3A and 3B, a reflector insert coupling feature 370 can be a clip that receives the reflector insert 380 in a friction fit. Other examples of a configuration of a reflector insert coupling feature 370 can include, but are not limited to, a tab, a detent, an aperture (through which a fastening device can be disposed), a slot, and a magnetized contact.

A reflector insert coupling feature 370 can merely receive a reflector insert 380 without actually coupling to a reflector insert 380. Alternatively, a reflector insert coupling feature 370 can couple to a reflector insert 380. If there are multiple reflector insert coupling features 370 disposed on a light chamber base 310, one reflector insert coupling feature 370 can have the same configuration as, or a different configuration than, one or more of the other reflector insert coupling features 370.

In addition to one or more reflector insert coupling features 370 being disposed on the light chamber base 310, or in the alternative, one or more reflector insert coupling features 370 can be disposed on an inner surface (facing the light chamber base 310) of the top surface 321 of the optical device 320. In such a case, the reflector insert coupling features 370 disposed on the optical device 320 can be substantially the same as, and/or different than, the reflector insert coupling features 370 disposed on the light chamber base 310.

When a reflector insert 380 is coupled to (e.g., disposed within) one or more reflector insert coupling features 370, the reflector insert 380 has a certain orientation with respect to the light source 335, the light chamber base 310, and/or some other feature of or associated with the light fixture 300. For example, as shown in FIGS. 3A and 3B, the reflector insert 380 can be disposed proximate to the light source 335. As another example, also as shown in FIGS. 3A and 3B, the reflector insert 380 can be positioned substantially parallel to the bottom end 303 of the housing 305, which also makes the reflector insert 380 substantially parallel to the floor (e.g., floor 296) when the light fixture 300 is attached squarely on the wall (e.g., wall 297).

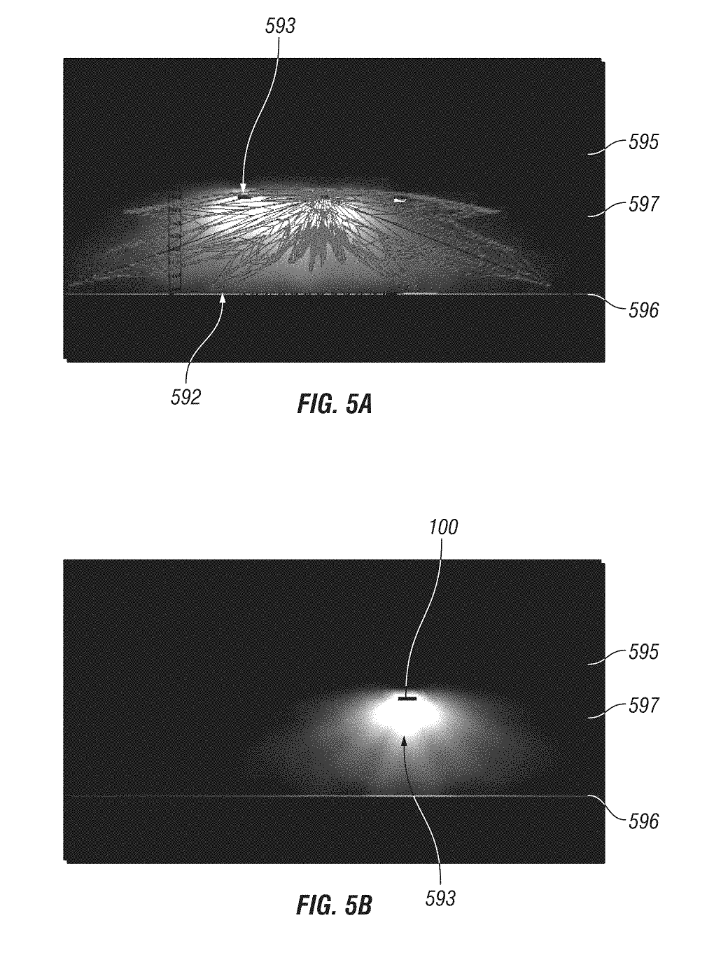

When a reflector insert 380 is inserted into one or more reflector insert coupling features 370 that are located between the light source 335 and the top end (adjacent to the top end 304 of the housing 305) of the light chamber base 310, the reflector can prevent at least some of the light emitted by the light source 335 from being directed toward the ceiling (e.g., ceiling 595 in FIGS. 5A and 5B below) by reflecting that light toward the floor (e.g., floor 596 in FIGS. 5A and 5B below).

In other words, the reflector insert 380 can act as a divider of the light chamber 330. For example, in the case of FIGS. 5A and 5B, the reflector inset 380 divides the light chamber 330 into an upper portion 330B and a lower portion 330A. Since the light source 335 is located (disposed) in the lower portion 330A of the light chamber 330, the upper portion 330B can be substantially dark when the light source 335 is illuminated.

The shape and the size of the reflector insert 380 can determine, at least in part, how much light generated by the light source 335 located in the lower portion 330A of the light chamber 330 is reflected back into the lower portion 330A of the light chamber 330 as opposed to being allowed to pass into the upper portion 330B of the light chamber 330. For example, as shown in FIG. 4, a reflector insert 380 can have a front surface 381, a rear surface (hidden from view but located opposite the front surface 381), a top edge 382, and a bottom edge 383.

If the bottom edge 383 of the reflector insert 380 has a contour that substantially complements the contour 311 of the light chamber base 310 and abuts against the entire length of the light chamber base 310, then most, if not all, of the light emitted by the light source 335 is reflected back into the lower portion 330A of the light chamber 330 rather than being allowed to pass into the upper portion 330B of the light chamber 330. If there are one or more reflector insert coupling features 370 disposed in the light chamber base 310, then the bottom edge 383 of the reflector insert 380 is disposed in (coupled to) those reflector insert coupling features 370.

Similarly, if the top edge 382 of the reflector insert 380 has a contour that substantially complements the contour of the top surface 321 of the optical device 320 and abuts against the entire length of the top surface 321 of the optical device 320, then most, if not all, of the light emitted by the light source 335 is reflected back into the lower portion 330A of the light chamber 330 rather than being allowed to pass into the upper portion 330B of the light chamber 330. If there are one or more reflector insert coupling features 370 disposed in the optical device 320, then the top edge 382 of the reflector insert 380 is disposed in (coupled to) those reflector insert coupling features 370.

The front surface 381 of the reflector insert 380 shown in FIGS. 3A-4 is substantially planar. Alternatively, the front surface 381 of the reflector insert 380 can be three-dimensional. In such a case, the front surface 381 of the reflector insert 380 can have one or more of a number of features, including but not limited to curvatures and angles. Similarly, the rear surface of the reflector insert 380 can be substantially planar or three-dimensional. The front surface 381 of the reflector insert 380 can be made of and/or coated with one or more of a number of reflective materials. Similarly, the rear surface of the reflector insert 380 can be made of and/or coated with one or more of a number of reflective materials.

The reflector insert coupling features 370 and/or the reflector inserts 380 can be configured in such a way that the reflector inserts 380 can be installed, removed, and/or replaced in the field (e.g., during installation of the light fixture 300) by a user. In certain example embodiments, a reflector insert 380 can be installed, removed, and/or replaced without the use of tools (e.g., screwdriver, wrench). In this way, if a user decides to mount the light fixture on a wall 597 rather than a ceiling 595, the user can easily install one or more reflector inserts 380 so that most, if not all, of the light generated by the light sources 335 is directed toward the floor 596 rather than toward the ceiling 595.

The example light fixture 300 can be a new light fixture. Alternatively, the example light fixture 300 can be an existing light fixture with one or more components that are replaced with example embodiments. For example, if the light chamber bases are detachable from the housing 305, then a user can replace one or more of the light chamber bases (having no reflector insert coupling features) with the light chamber bases 310 each having one or more reflector insert coupling features 370. As another example, if the optical devices are detachable from the housing 305, then a user can replace one or more of the optical devices (having no reflector insert coupling features) with the optical devices 320 each having one or more reflector insert coupling features 370.

FIGS. 5A and 5B show light distribution of the example emergency egress light fixture 300 of FIGS. 3A and 3B in accordance with embodiments known in the art. Specifically, FIG. 5A shows a graphical representation 592 (overlayed on a visual representation 593) of the light dispersion pattern, and FIG. 5B shows the visual representation 593 of the light dispersion pattern by itself. The light fixture 300 is hidden from view in FIG. 5A by the graphical representation 592.

When the light fixture 300 is mounted on a wall 597, as shown in FIGS. 5A and 5B, the light dispersion pattern, represented both by the graphical representation 592 and the visual representation 593, is directed outward and downward (relative to the light fixture 300) toward the floor 596 and away from the ceiling 595. As a result, the vast majority of the light emitted by the light fixture 300 in example embodiments is used to provide illumination for people, both during normal conditions and during emergencies, in what are often otherwise darkly lit spaces. Thus, unlike light fixtures (e.g., light fixture 100) currently used in the art, the light is not directed toward the ceiling 595, and so little of the light is wasted.

Example embodiments described herein allow an emergency egress light fixture to distribute light such that substantially all of the light generated by the light sources of the light fixture are directed toward a floor rather than toward a ceiling. The reflector inserts described herein can be installed and/or removed from an example light fixture by a user in the field without the use of tools. The reflector inserts described herein can be installed and/or removed in a new light fixture or as a retrofit for an existing light fixture. The example reflector inserts can be assembled without risk of injury, risk of damage to the various components of the light fixture, and in an efficient manner. Example embodiments can also be used in environments that require compliance with one or more standards and/or regulations.

Accordingly, many modifications and other embodiments set forth herein will come to mind to one skilled in the art to which example reflector inserts for emergency egress light fixtures pertain having the benefit of the teachings presented in the foregoing descriptions and the associated drawings. Therefore, it is to be understood that example reflector inserts for emergency egress light fixtures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. An emergency egress light fixture, comprising:
a first light chamber base forming a first light chamber, wherein the first light chamber base comprises at least one first reflector insert coupling feature;
at least one first light source disposed in the first light chamber; and
a first reflector insert disposed within the at least one first reflector insert coupling feature, wherein the first reflector insert divides the first light chamber into a first portion and a second portion, wherein the at least one first light source is disposed in the first portion, and wherein the second portion is substantially dark when the at least one first light source is illuminated.

2. The emergency egress light fixture of claim 1, further comprising:
a first optical device coupled to the first light chamber base, wherein the first optical device abuts against a top edge of the first reflector insert.

3. The emergency egress light fixture of claim 2, wherein the first optical device comprises at least one additional first reflector insert coupling feature, wherein the top edge of the first reflector insert is disposed in the at least one additional first reflector insert coupling feature.

4. The emergency egress light fixture of claim 2, wherein the top edge of the first reflector has an optical device contour that substantially complements the optical device contour of the first optical device.

5. The emergency egress light fixture of claim 1, wherein the first reflector insert comprises a bottom edge having a contour that substantially complements a contour of the first light chamber base.

6. The emergency egress light fixture of claim 1, wherein the first light chamber base comprises a reflective outer surface.

7. The emergency egress light fixture of claim 1, wherein the first light source is located adjacent to the first reflector insert.

8. The emergency egress light fixture of claim 1, wherein the first light source is disposed between the first reflector insert and a floor.

9. The emergency egress light fixture of claim 8, wherein light emitted by the first light source is directed toward the floor by the first reflector insert.

10. The emergency egress light fixture of claim 8, wherein the first reflector insert is substantially parallel with the floor.

11. The emergency egress light fixture of claim 1, wherein the at least one first light source comprises a light-emitting diode.

12. The emergency egress light fixture of claim 1, wherein the first reflector insert can be removed by a user without tools.

13. The emergency egress light fixture of claim 1, further comprising:
a second light chamber base forming a second light chamber, wherein the second light chamber base comprises at least one second reflector insert coupling feature;
at least one second light source disposed in the second light chamber; and
a second reflector insert disposed within the at least one second reflector insert coupling feature, wherein the second reflector insert divides the second light chamber into a third portion and a fourth portion, wherein the at least one second light source is disposed in the third portion, and wherein the fourth portion is substantially dark when the at least one second light source is illuminated.

14. The emergency egress light fixture of claim 13, further comprising:
a housing disposed between the first light chamber and the second light chamber, wherein the housing forms a cavity inside of which is disposed electrical equipment that provide power to the at least one first light source and the at least one second light source, wherein the housing is disposed on a wall.

15. The emergency egress light fixture of claim 1, wherein the first reflector insert is inserted into the at least one first reflector insert coupling feature of the first light chamber base by a user during installation.

16. The emergency egress light fixture of claim 1, wherein the first reflector insert is substantially planar.

17. A reflector insert for an emergency egress light fixture, wherein the reflector insert comprises:
a body comprising a first side and a second side, wherein the first side is reflective;
a bottom edge positioned adjacent to the first side and the second side, wherein the bottom edge has a light chamber base contour that substantially complements the light chamber base contour of a light chamber base of the emergency egress light fixture,
wherein the bottom edge is configured to be disposed within at least one reflector insert coupling feature of the light chamber base,
wherein the body divides a light chamber formed by the light chamber base into a first portion and a second portion, wherein at least one first light source is disposed in the first portion, wherein the first side of the body faces the first portion, and wherein the second portion is substantially dark when the at least one first light source is illuminated.

18. The reflector insert of claim 17, further comprising:
a top edge positioned adjacent to the first side and the second side, wherein the top edge has an optical device contour that substantially complements the optical device contour of an optical device coupled to the light chamber base of the emergency egress light fixture.

19. The reflector insert of claim 17, wherein the second side of the body is reflective.

20. An emergency egress light fixture, comprising:
a light chamber base forming a light chamber;
at least one light source disposed in the first light chamber;
an optical device coupled to the light chamber base, wherein the light chamber base comprises at least one reflector insert coupling feature; and
a reflector insert disposed within the at least one reflector insert coupling feature, wherein the reflector insert divides the light chamber into a first portion and a second portion, wherein the at least one light source is disposed in the first portion, and wherein the second portion is substantially dark when the at least one light source is illuminated.
